(19) United States
(12) Patent Application Publication
(10) Pub. No.: US 2022/0288997 A1
(43) Pub. Date: Sep. 15, 2022

(54) Infrared Radiative Heater using Low Effusively Cover Materials

(71) Applicant: GENTHERM INCORPORATED, Northville, MI (US)

(72) Inventors: James Frederick Krier, Grosse Pointe Woods, MI (US); Rudiger Spillner, Augsburg (DE); Regina Hanslmeier, Muenchen (DE); Jens Keller, Nürtingen (DE); Vladimir Jovovic, Pasadena, PA (US)

(21) Appl. No.: 17/632,351

(22) PCT Filed: Sep. 10, 2020
(86) PCT No.: PCT/US2020/050101

§ 371 Date: Feb. 2, 2022

Related U.S. Application Data
(60) Provisional application No. 62/900,117, filed on Sep. 13, 2019.

(51) Int. Cl. B60H 1/22; H05B 3/14; H05B 3/34

(52) U.S. Cl. CPC B60H 1/2226; B60H 1/2227; H05B 3/14; H05B 3/34

(57) ABSTRACT

A heater having a cover and a heating element. The heating element is configured to generate heat that is transferred through the cover via radiative heating and/or conductive heating. The cover has a thermal effusivity in a range of about 20-300 Ws⁽¹⁻²⁾/m²K

### FIELD

This application claims priority to U.S. 62/900,117 filed Sep. 13, 2019, the entire disclosure of which is hereby incorporated by reference herein for all purposes.

### FIELD

These teachings relate to a heater that may be used in vehicular applications, and more specifically to an infrared radiative heater that includes a low effusivity cover material.

### BACKGROUND

Typically, infrared heaters located inside of a vehicle are hidden from view because of their non-Class A appearance, which undesirably limits the location choices for the heaters and also undesirably moves the heaters from effective locations in the vehicle for thermal comfort to less effective locations.

Moreover, many infrared heaters located inside of a vehicle are covered by unsightly protective grills. Furthermore, many vehicle infrared heater designs do not permit styled surface materials to be used that permit extended object and/or human skin contact at temperatures needed for effective radiation heat transfer without burning or damaging the object and/or human skin.

Accordingly, it may be desirable to overcome at least some of the aforementioned deficiencies in vehicle heaters to improve the current state of the art.

For example, it may be desirable to have an infrared heater for a vehicle that can be seamlessly integrated into a vehicle class A surface for direct and effective thermal comfort of an object or occupant inside the vehicle. It may be desirable to have an infrared heater for a vehicle that can be integrated into a vehicle class A surface that is flat and/or curved, such as a vehicle instrument panel or dashboard, a door panel, a steering wheel, a seat or seat back, or a combination thereof. It may be desirable to have an infrared heater that permits extended object and/or human skin contact at temperatures needed for effective radiation heat transfer without burning or damaging the object and/or human skin.

### SUMMARY

These teachings provide a heater. The heater has a cover and a heating element or heating layer. The heating element or layer is configured to generate heat that is then transferred through the cover material or layer via radiative heating and/or conductive heating. The cover material or layer may have a thermal effusivity in a range of about 20-300 Ws⁽¹⁻²⁾/m²K.

These teachings provide a heater having a cover, a heating element, and a power source. The heating element is connected with the power source and configured to generate heat with power supplied by the power source. The generated heat is transferred through the cover via radiative heating and/or conductive heating. The cover has a thermal effusivity in a range of about 20-300 Ws⁽¹⁻²⁾/m²K.

These teachings provide an infrared heater for a vehicle that can be seamlessly integrated into a vehicle class A surface for direct and effective thermal comfort of an object or occupant inside the vehicle. These teachings also provide an infrared heater for a vehicle that can be integrated into a vehicle class A surface that is flat and/or curved, such as a vehicle instrument panel or dashboard, a door panel, a steering wheel, a seat or seat back, or a combination thereof. These teachings provide an infrared heater that permits extended object and/or human skin contact at temperatures needed for effective radiation heat transfer without burning or damaging the object and/or human skin.

These teachings provide a heater comprising: a cover; a power source; and a heating element. The heating element is connected with the power source and configured to generate heat with power supplied by the power source, the generated heat is transferred through the cover via radiative heating and/or conductive heating. The cover comprises a thermal effusivity in a range of about 20-300 Ws⁽¹⁻²⁾/m²K. The radiative heating is in a range between about 42° C. and 120° C. The heater comprises a spacer disposed between the heating element and the cover. The spacer comprises a thermal effusivity in a range of about 20-300 Ws^{(1/2)}/m2K. The heater comprises an detector that is configured to detect contact of the cover with an object or a proximity of the object relative to the cover and then reduce the heat generated by the heater after detecting contact of the cover with the object or the proximity of the object relative to the cover. The detector comprises a capacitive touch sensor. A vehicle seat and/or a vehicle dashboard and/or a vehicle headliner may comprise a heater according to any of these teachings.

### BRIEF DESCRIPTION OF THE DRAWINGS

FIG. 1 is a schematic of a heater according to these teachings.

FIG. 2 is a schematic of a heater according to these teachings.

FIG. 3 is a partial cross-sectional view of a vehicle.

FIG. 4 is a schematic of a heater according to these teachings.

FIG. 5 is a schematic of a heater according to these teachings.

FIG. 6 is a schematic of a heater according to these teachings.

FIG. 7 is a schematic of a heater according to these teachings.

FIG. 8 is a schematic of a heater according to these teachings.

FIG. 9 is a schematic of a heater according to these teachings.

FIG. 10 is a schematic of a heater according to these teachings.

FIG. 11 is a schematic of a heater according to these teachings.

### DETAILED DESCRIPTION

These teachings relate to a heater. The heater may find use in automotive and non-automotive applications. For example, the heater may be used to provide heating to an object or person. The surface may be virtually any surface inside an automobile, such as, for example, a headliner, a dashboard, a door panel, a center counsel, a floor mat, a food well, a seat, a seat cushion, a seat back, a seat bolster, a sun roof shade, sun visor, etc. or a combination thereof. In non-automotive applications, the heater may be used in hospitals or medical facilities to provide warmth to a patient. For example, the heater may be used in an operating room and incorporated into the walls and/or floors.

The heater and/or the one or more layers of the heater may be formed into a flat, planar structure. The heater and/or the one or more layers of the heater may be formed into single or multiple degree of curvature geometry (i.e., cylindrical, conic, spherical, splines, etc.), which may be advantageous for A-surface features like dashboards, center consoles, door panels, dashboards, steering wheels, etc.

The heater according to these teachings may support vehicle interior impact regulations, such as FMVSS201 and/or ECE R21, which dictate energy absorbing methods in case of a crash condition. The heater according to these teachings preferably avoids sharp or rigid corners, that may be typical of a traditional encased radiative heater.

Any disclosure herein relating to the heater may apply to all examples and embodiments.

The heater may include one or more layers. The one or more layers may be any of the layers disclosed herein. The one or more layers may be arranged in virtually any order. One or more of the layers disclosed herein may be duplicated. This means that the heater may comprise one or more of the same layers. The one or more of the same layers may be stacked on top of one another. The one or more of the same layers may be separated by one or more other layers or air gaps. One or more of the layers disclosed herein may be omitted or removed from the heater. One or more of the layers may be split into one or more other layers. For example, a layer may be disclosed as having a thickness of 4 mm. The 4 mm layer may be split into two layers, each 2 mm thick. The two layers each 2 mm thick may be stacked on top of each other, in direct contact with one another. Alternatively, the two layers each 2 mm thick may be separated by one or more of the other layers disclosed herein. The one or more layers of the heater may include: one or more cover layers, one or more safety mechanisms, one or more insulators or spacers, one or more guards, dielectrics, one or more heaters or heating layers, one or more insulators, one or more standoffs, one or more supports, one or more support structures, or a combination thereof. The one or more dielectrics may be an electrical insulation that can transmit electric force with conduction. The one or more dielectrics may be an insulator.

The one or more layers may be located adjacent to one another. The one or more layers may be directly connected together. The one or more layers may be connected together via one or more adhesives and/or fasteners, like glue, welding, pins, screws, welds, hook and loop fasteners, rivets, stitching, etc. The one or more layers may be laid on top of one another without any mechanical fasteners or adhesives. The one or more layers may be spaced apart from one another (i.e., one or more air gaps defined between adjacent layers).

Any disclosure herein relating to the one or more layers may apply to all examples and embodiments.

The one or more layers may comprise one or more guards. The one or more guards may comprise a material TECNIT (available from Parker Chomerics). The one or more guards may include a silver-plated glass filled conductive material, design for use as a sealant on electrical enclosures for EMI shielding or electrical grounding. The guard material may be flexible, which may advantageously allow the heater to bend and/or conform to the various surfaces that it is to be applied to. The one or more guards may be attached to or integrated with one or more layers, like the heating layer for example.

The heater may include one or more covers or cover layer. The cover may also be referred to herein as a trim or trim layer. A cover layer may be a surface or layer that is visible to an occupant inside of a vehicle. The cover layer may include one or more textures, grains, profiles, colors, apertures, holes, indentations, protrusions, protuberances, bumps, grooves, stippling, or a combination thereof. The cover layer may have raised and lowered surfaces (i.e., surfaces at different heights) to reduce the surface contact area with an object or occupant in contact with the cover layer. The cover layer may be made of a fabric, such as a plastic or leather. The cover layer may include flocking. A cover layer with flocking may be used in any A-surface application, such as a headliner for example. The cover layer may be a soft, deformable, pliable, and/or formable material. The cover layer may be made of a rigid material like plastic, wood, metal, carbon fiber, etc. The cover layer may be low density, low effusively, low thermal conductivity, or a combination thereof. The cover layer may be made of a wove or non-woven fabric. The cover layer may be air permeable. The cover layer may be non-air permeable. The cover layer may include one or more holes or apertures to permit a path for radiative heat transfer from the heating element to the object or occupant and to further lower the effusivity of heater and/or cover layer. Preferably, the cover layer has the ability or configured to exchange heat with the surrounding environment, without burning or causing discomfort to an object or person in contact with the cover layer or in close proximity to the cover layer.

The heater may include one or more heating elements or heating layers. A heating layer and heating element may be used interchangeably herein. A heating element or heating layer may be a heating source. The heating layer may be an infrared heater. A heating element or heating layer may comprise carbon fiber heaters on woven or nonwoven carrier materials. A heating element or layer may comprise a stitched and/or woven carbon fiber. The heating element or layer may comprise a woven, nonwoven, or mesh carrier. A heating element or layer may comprise a graphite sheet with a resistive pattern designed with cuts in the sheet to allow the heating element or layer to bend or conform to the heater and/or cover surface or layer. A heating element may include a conductive polymer coating. A heating element or heating layer may be free of a polymer foil and/or sheets such as laminated polyurethane (PU), Polyvinyl chloride (PVC), and/or polyethylene terephthalate (PET). The heating element is preferably decoupled (i.e., spaced apart and/or not in contact with) one or more structural elements to reduce a thermal mass of the heating element. The structural elements may be made of plastic, metal, wood. The heating element or heating layer preferably has a low thermal mass with a fast time constant.

The heating element may generate and transfer heat to one or more adjacent layers via radiation, conduction, or both. Radiative transfer may occur when there is open spaces or gaps defined between adjacent layers. The open spaces or gaps may be formed or defined by separating the layers of the heater and/or by providing one or more holes or apertures in the adjacent layers of the heater. Conductive transfer may occur when one or more of the layers or portions of the layers are in contact with the heating element and/or one or more layers of the heater.

The heating element may comprise flocking. The heating element may include an adhesive and flocking applied onto the adhesive. The flocking may serve as the cover surface or layer. Flocking may be advantageous in that additional cover layers or materials may not be needed. In other words, the cover or trim layer may be omitted if a flocking material is applied to the heater. However, in other configurations, a cover layer or surface may be applied over the flocking. The flocking may advantageously accommodate different thermal expansion from heating hot spots in the cover layer or surface that may cause undesirable read through issues. The flocking fibers may move locally with different thermal expansion locations.

The heater may include one or more insulators, insulation layers, spacers, and/or spacer layers. An insulator or spacer layer may be provided between one or more of the layers of the heater and/or between the heater and any structural elements. An insulator or spacer layer may be open and/or closed cell foam. An insulator or spacer layer may be a woven, non-woven, or mesh carrier.

An insulator or spacer layer may be a 3D textile. An insulator or spacer layer may be a 3MESH4® spacer fabric from Muller Textiles. An insulator or spacer layer may have large pores to allow circulation of air in the back side of the heater element to accelerate cool down of the heating element, the heater, the one or more layers of the heater, or a combination thereof.

The insulation or spacer layer may have virtually any suitable thickness. For example, the insulation or spacer layer may have a thickness on the other of about 2 mm or more, 4 mm or more, 6 mm or more, 8 mm or more, 10 mm or more, 15 mm or more, 20 mm or more, etc.

The insulation or spacer layer may have a suitable weight. For example, the insulation or spacer layer may have a weight of 10 g or more, 20 g or more, 30 g or more, 40 g or more, 50 g, or more, 60 g or more, 80 g or more 100 g or more.

The heater may include one or more detectors. A detector may be an active safety mechanism. A detector may function to sense contact or proximity of an object or occupant to the heater, the one or more layers of the heater, the cover layer, or a combination thereof. After sensing contact or proximity of an object or occupant to the heater or one or more layers of the heater, the detector may function to reduce or cut power to the one or more heating layers and/or reduce a power or heat output from the heater or the one or more heating layers to cool or reduce a surface temperature of the heater or cover layer. The detector may comprise one or more sensors that include capacitive touch, force sensitive resistance touch, or other sensing methods, such as acoustic or optical methods. A detector may be one or more of the layers in the heater. A detector may be combined or integrated with one or more other layers in the heater.

The heater may include one or more open spaces or open layers. An open space or open layer may be defined between or adjacent two or more of any of the layers of the heater. An open space or layer may be an aperture, hole, or void defined in one or more of the layers. An open space or open layer may be a portion of the heater where no layer exists. The open space or layer may be defined between two layers that are spaced apart from one another via one or more spacers or standoffs. The one or more standoffs or spacers may function to prevent a collapse of the open space or open layer by the adjacent layers of the heater. The open space or open layer may have virtually any thickness. The one or more open spaces or layers may provide for heat to be transferred. The one or more open spaces may provide for heat to be transferred via radiation. The one or more open spaces may be defined adjacent the heater layer. The one or more open spaces may be partially or completely filled with one or more layers disclosed herein.

The heater and/or the one or more layers of the heater may include a support structure. The support structure may function to support the heater. The support structure may be a frame or other supporting structure of one or more components of a vehicle, such as, for example: a dashboard, a steering wheel, a back and/or bottom cushions, a seat back, a headliner, or a combination thereof.

The support structure may be a shield that functions to redirect thermal energy back to the heating surface, the cover layer, or both to increase efficiency of the heater. The overall thermal resistance between the heater and support structure may be higher than the thermal resistance between the heater and cover layer to ensure that the generated heat is transferred from the heating element in a direction to the cover and towards the occupant or target, as opposed to the generated heat transferring to or in a direction of the support structure.

A shield or support structure may be located on a back side of the heating layer. A shield or support structure may be located on a back side of any layer and/or between any of the layers disclosed herein. A shield or support structure may be integrated with any of the layers. For example, the shield or support structure may be integrated with the heating layer. That is, the shield may be attached or connected to the heater.

The support structure may be made of a material such as metal, plastic, wood, composite, or a combination thereof. The support structure may be a woven, non-woven, or mesh carrier.

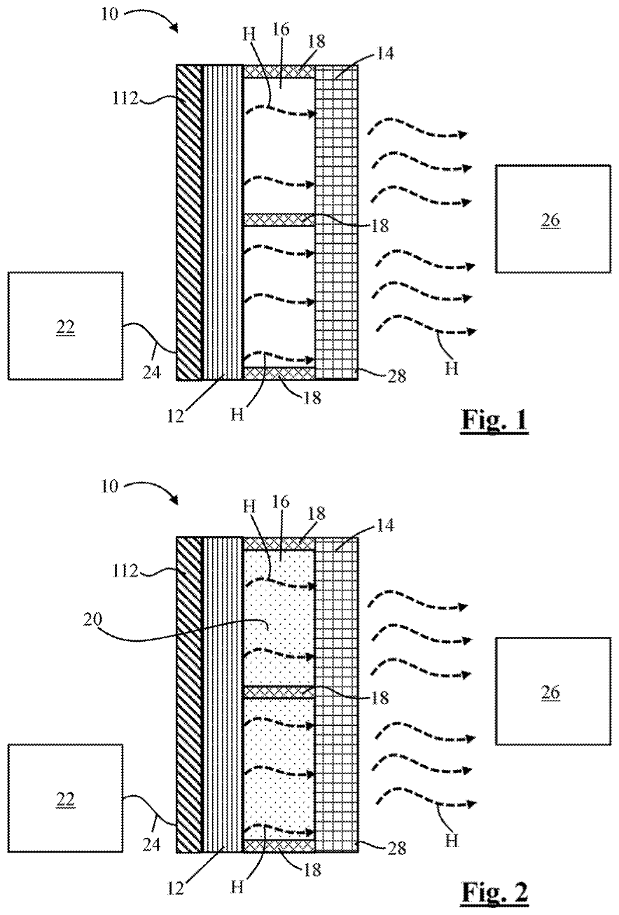

FIGS. 1 and 2 each illustrate a heater 10. The heater 10 comprises layers that include a heating element or layer 12 and a cover or cover layer 14. The cover 14 is decoupled or spaced apart from the heating element 12 thereby defining an open space 16 or open layer therebetween.

The heater 10 may comprise one or more stand-offs or spacers 18 provided or located in the open space 16 and disposed between the any of the layers of any of the heaters 10 disclosed herein. In FIGS. 1 and 2, the stand-offs or spacers 18 are provided between the heating element or layer 12 and the cover or cover layer 14 to maintain the layers (the heating element 12 and the cover 14) at least partially separated at a distance. The one or more stand-offs or spacers 18 may be joint structures, like adhesives or welded contacts connecting together the layers (i.e., the heating element 12 an the cover 14) and/or infrared porous interface materials sufficient to create and maintain at least the gap or open space 16 between the layers. Any description relating to the heater, the one or more layers or components of the heater, for example, the stand-offs or spacers, and/or the structure and orientation of the heater and/or one or more layers of the heater may apply to any and all examples disclosed herein.

Additionally, or alternatively, the open space 16 may include one or more layers 20 (For example see FIG. 2). The one or more layers 20 may include any of the one or more layers disclosed herein. For example, the one or more layers may include one or more: active safety mechanisms or layers, insulators, spacers, guards, stand-offs, heaters, or a combination thereof.

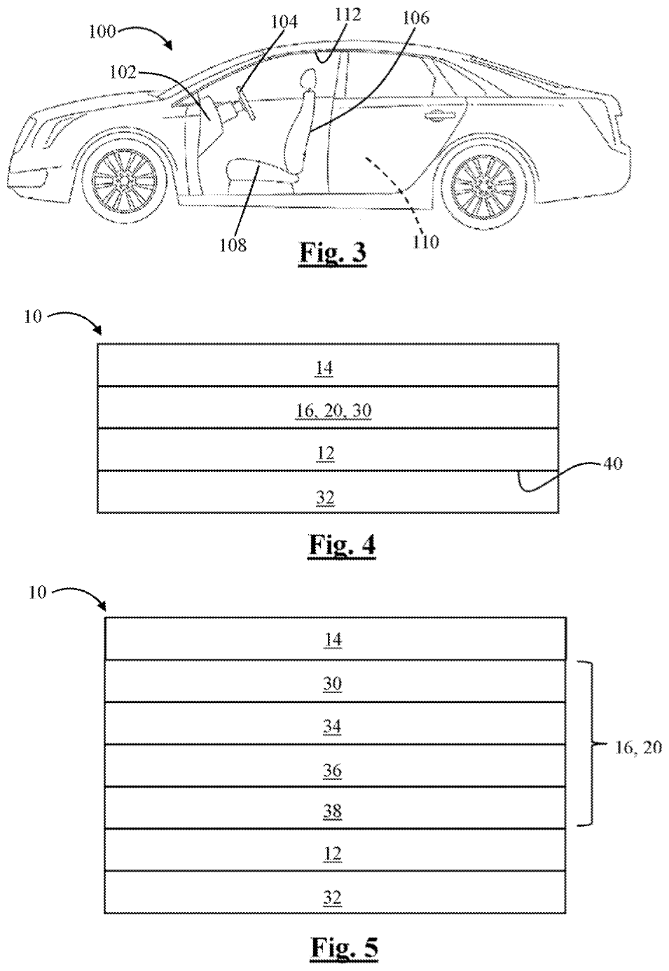

The heater 10 and/or the heating element 12 is configured to connect with a power source 22 via one or more wire conductors 24. The power source 22 may be any power source, for example a vehicle battery and/or alternator, or the power source 22 may be a dedicated power source 22 for the heater 12. The power source 12 is configured to supply the heater 10 and/or heating element 12 with electrical power, which then causes the heater 10 and/or heating element 12 to generate heat H. The heat H generated by the heater 10 and/or heating element 12 may be transferred into and through the open space 16 and/or one or more layers 20 of the heater 12 via radiative heating and/or via conductive heating through the one or more standoffs 18 and/or layers 20. The heat H may then be transferred through the cover layer 14 to provide radiative heating and/or conductive heating to an object or target 26 on that side of the heater 10. The object or target 26 may be an object or person inside of a motor vehicle 100 (FIG. 3) that is located adjacent the heater 10 and/or cover 14.

The heater 10 and/or heating element 12 may optionally be attached to or provided adjacent a support structure 112. The support structure 112 may be a frame or other supporting structure. With additional reference to FIG. 3, the support structure 112 may be a frame or support of one or more components of a vehicle 100, such as, for example: a dashboard 102, a steering wheel 104, a back and/or bottom cushions 106, 108, a seat back 110, a headliner 112, or a combination thereof. Other features of the vehicle 100 that may also include the support structure 112 to or on which the heater 10 may be connected or provided adjacent to is: cup holders, rear seats, center counsel, headrests, visors, sun roof shades, seat bolsters, door panels, floor mats, foot wells, etc., or a combination thereof. The cover layer 14 of the heater 10 may be an A-surface of any of the features within the vehicle 100, meaning the surface that is visible to and/or can be touched by an occupant in the vehicle 100.

The heater 10 and/or heating element 12 may be directly connected to the support structure 112; may be provided adjacent to the support structure 112 such that a gap is defined between the support structure 112 and the back side of the heater 10 (or any of the layers of the heater 10; or may have one or more layers discussed further below (i.e., layers 34, 36, 32 illustrated in FIGS. 4-7) provided between the back side of the heater 10 and/or heating element 12 and the support structure 112.

The overall thermal resistance between the heating layer or element 12 and/or heater 10 and support structure 112 may be higher than the thermal resistance between the heating layer element 12 and/or heater 10 and cover layer 14 to ensure that the generated heat H is transferred from the heating element 12 in a direction to the cover 14 and towards the occupant or target 26, as opposed to or rather than the generated heat H transferring to or in an opposite direction towards the support structure 112.

With continued reference to FIGS. 1 and 2, the heating element 12 may be any heater that is configured to generate heat H when supplied with electrical power. For example, the heating element 12 may be an infrared heater, a resistive wire heater, a carbon fiber heater. The heating element 12 may be a carbon fiber heater provided or stitched on a woven, nonwoven, and/or fleece substrate or carrier. The heating element 12 may be a graphite sheet with one or more resistive patterns designed with cuts, slits, or apertures defined in the sheet to allow the sheet to conform to a curved surface or support structure.

The heating element 12 may be configured to generate heat to virtually any temperature. For example, the heating element 12 may generate heat at a temperature that is greater than about 30 degrees Celsius or more, 40 degrees Celsius or more, 50 degrees Celsius or more, 60 degrees Celsius or more, 70 degrees Celsius or more, 80 degrees Celsius or more, 90 degrees Celsius or more, 100 degrees Celsius or more, 110 degrees Celsius or more, 120 degrees Celsius or more, 130 degrees Celsius or more, 140 degrees Celsius or more, 150 degrees Celsius or more, 160 degrees Celsius or more, etc. Preferably, the heating element 12 is configured to generate heat at a temperature at or between about 50 degrees Celsius to about 150 degrees Celsius.

The heating element 12 may be configured to generate a heat flux at or between any range, but preferably within a range between 500-5000 W/m². The heat flux of the radiative heating is greater than a heat flux of the conductive heating. Preferably, the heating element 12 has a low thermal mass with a fast time constant. The heating element 12 may have any heat flux, q, but preferably a heat flux, q, greater than about 3000 W/m².

The heating element 12 may be generally flexible and able to conform to a variety of straight or flat surfaces and/or curved surfaces, such as various spherical and spline surfaces having a single degree of curvature, two degree of curvature. etc.

In some configurations, the heater 10 and/or the heating element 12 may be configured to heat the cover layer 14 to a predetermined temperature, and then maintain the cover 14 at the predetermined temperature. In this regard, one or more sensors may be provided on the heater 10, the heating element 12, the cover 14, and/or any other layer to turn on, turn off, maintain, and/or regulate the heater 10 or heating element 12. In other configurations, the heater 10 and/or the heating element 12 may be configured to heat the cover 14 to a predetermined temperature, and then drop or lower a temperature of the cover 14 to a second predetermined temperature that is lower than the first or original predetermined temperature. The heater 10 and/or the heating element 12 may be configured to maintain the temperature of the cover 14 at the predetermined temperature or the second, lower predetermined temperature during a condition when the cover 14 is free of contact with the object or target 26.

In some configurations, after the heater 10 and/or heating element 12 is configured to determine when the cover 14 is in contact with the object or target 26, or the object or target 26 is in close proximity to the cover 14, the heater 10 and/or the heating element 12 is configured to cool, reduce, or lower the temperature to below the predetermined temperature or the second, lower predetermined temperature. This is described further below with reference to the detector 30, which may also be referred to as a safety mechanism or active safety mechanism. For example, after the heater 10 and/or heating element 12 determines that the cover 14 is in contact with the object or target 26, or the object or target 26 is in close proximity to the cover 14, the heating element 12 is configured to cool, reduce, or lower the temperature a temperature in a certain time period to reduce or prevent burning the object or target 26. The temperature may be lowered to about 100 degrees Celsius or less, 90 degrees Celsius or less, 80 degrees Celsius or less, 70 degrees Celsius or less, 60 degrees Celsius or less, 50 degrees Celsius or less, 45 degrees Celsius or less, 40 degrees Celsius or less, etc. The time period this may be achieved in may be about 5 minutes or less, 4 minutes or less, 3 minutes or less, 2 minutes or less, 1 minute or less, 50 seconds or less, 40 seconds or less, 30 seconds or less, 20 seconds or less, 10 seconds or less, 5 seconds or less, etc.

With continued reference to FIGS. 1 and 2, the cover layer 14 is spaced apart or decoupled from the heating element 12 as shown in the FIGS. 1 and 2 thereby defining an open space 16 therebetween. The spacing apart or uncoupling of the cover 14 and heating element 12 may provide for heat transfer by radiation as the primary heat transfer method between the heating element 12 and the cover 14 and enables extended touch time between the object or target 26 and the cover 14 without burning the object or target 26 due to the effective thermal mass of the cover 14 being less than or smaller than designs that do not have an open space 16 or do not primarily rely on radiative heat transfer between the heating element 12 and the cover 14.

However, in some configurations, the cover 14 may be in direct contact with the heating element 12, and in such configurations the heat H from the heating element 12 may also or instead be transferred to the cover 14 by way of conduction.

The cover or cover layer 14 is preferably made of an organic material. The cover 14 may include a woven or non-woven material, a rigid material, a soft or flexible material, or a combination thereof. For example, the cover 14 may be constructed from or include: plastic, polyester, cotton, wool, wood, Polyethylene (PE), Polyethylene terephthalate (PET), Polyurethane (PU), composites thereof, or any combination thereof. In some configurations, even inorganic materials, like fiberglass, may be used.

The cover 14 may be made of a low-density fabric, a woven or a non-woven fabric or material, and/or a porous material. A low-density and/or porous cover 14 advantageously provides for, allows, and/or encourages the infrared heat radiation from the heating element 12 to move or transfer through the pores and/or openings in the cover 14.

The cover 14 may be constructed of a low thermal effusivity and/or low thermal conductivity material, which may advantageously allow or provide for the heating element 12 to efficiently and effectively provide and exchange heat with the object or target 26.

With additional reference back to FIGS. 1-2, the cover 14 may have a first or “A” surface 28. The A surface 28 may be a class A automotive surface that is visible to a person or occupant of the vehicle and can be touched by the occupant. For example, the A surface 28 may include coloring, grain, patterns, textures, surfaces, and/other styling attributes.

The first or A surface 28 of the cover 14 may also include a texture, bumps, grooves, apertures, projections, etc. to reduce the contactable surface of the cover 14 by the object or target 26. The cover 14 may be porous and/or may include apertures, holes, or openings defined in or through the first or A surface 28 to permit or allow radiative heat transfer from the heating element 12 to the object or target 26, and also to further lower the thermal effusivity of the cover 14, discussed below.

For example, referring to FIG. 3 where a vehicle 100 is illustrated, the heater 10 and/or the first or A surface 28 may be part of or may be the outer surface of the dashboard 102, the steering wheel 104, the back and bottom cushions 106, 108, the seat back 110, the headliner 112, or a combination thereof. Other features of the vehicle may also include the heater 10 according to these teachings, including one or more of the cup holders, rear seats, center counsel, headrests, etc. The heater 10 according to any of the teachings disclosed herein may also find use in non-class A vehicle surfaces. For example, the heater 10 may be provided under a seat and/or in a foot well.

The cover layer 14, the one or more layers 20, or a combination thereof may have a preferred thermal effusivity. Thermal effusivity is a material property describing the ability of a material (i.e., the cover 14 and/or the one or more layers 20, if applicable) to transfer heat. Stated another way, thermal effusivity is the rate at which the cover 14 and/or the one or more layers 20 can absorb heat, or how well the cover 14 and/or the one or more layers 20 can exchange heat with the object or target 26 that is in contact with the cover 14 or the A-surface 28 thereof or in close proximity thereto.

Thermal effusivity can be expressed by the following equation:

e=(kpCp)^{1/2}

where: e is the thermal effusivity measured in Ws^{(1/2)}/m2K or J/s^{(1/2)}m2K;

p is density of the material in kg/m³;

Cp is the specific heat capacity in J/kg/K; and

k is the thermal conductivity in W/mK;

For example, assuming the cover layer 14 has a thermal effusivity e1 and a temperature t1, and the object or target 26 that contacts the cover 14 has a thermal effusivity e2 that is lower than the thermal effusivity e1 and a temperature t2 that is lower than the temperature t1, the temperature at the interface T_{interface} or contact area of the cover 14 and the object or target 26 is dictated by the higher thermal effusivity e1, i.e., the cover 14. This is modeled by the following equation:

T_{interface}=(T1*e1+T2*e2)/(e1+e2)

Accordingly, it is preferred that cover 14 and the layers 20, if applicable, have a low thermal effusivity. Low thermal effusivity may refer to a value of less than about 500 Ws^{(1/2)}/m²K. More preferably, low thermal effusivity of the cover 14 and/or layers 20 may be less than 400 Ws^{(1/2)}/m²K. Most preferably, the thermal effusivity of the cover 14 and/layers 20 may be less than 300 Ws^{(1/2)}/m²K. The thermal effusivity of the cover 14 may be within a range of about 20 to about 300 Ws^{(1/2)}/m²K. Having a low thermal effusivity of the cover 14 and/or lavers 20 advantageously drives the ability to run the heating element 12 at a higher temperature to improve the radiant heat transfer to the object or target 26.

For reference, Table 1 below lists sample thermal effusivity values of various materials:

TABLE 1

| | Thermal Effusivity |
|---|---|
| Material | [Ws^{(1/2)}/m²K] |
| Air | 6 |
| Polystyrene, rigid foam | 65 |
| Spacer fabric | 95 |
| Ultrasuede | 234 |
| Fabric | 274 |
| Leather (natural) | 425 |
| Epoxy (unfilled) | 468 |
| Rubber (natural) | 518 |
| PMMA | 601 |
| Fabric (wet, saturated) | 1400 |
| Window, glass | 1569 |
| Metals | >10000 |

The cover 14 and the layers 20, if applicable, may be comprised of one or more porous materials that are preferably not easily compressible because the effective thermal effusivity thus includes air in the pores and native materials, both of which have a very low thermal effusivity (i.e., air has a thermal effusivity of 6, see above Table 1).

The cover 14 and/or the layers 20 may have a high thermal emissivity. Thermal emissivity refers to the effectiveness of cover 14 and/or the layers 20 in emitting energy as thermal radiation and thus heat energy. Preferably, the cover 14 and/or the layers 20 have a high thermal emissivity on the order of about 0.8 and 0.95.

Again, any description relating to the heater, the one or more layers or components of the heater, and/or the structure, function, and/or orientation of the heater and/or one or more layers of the heater discussed herein, including the teachings of FIGS. 1, 2, and/or 3, may apply to any and all examples disclosed herein. The structure and/or function of the heater and/or any of the layers of the heater described in any of the other figures herein may also apply to any of the embodiments described in any of the figures.

FIG. 4 illustrates a heater 10. Like numerals represent similar features; thus, their structure and function will not be repeated. The heater 10 of FIG. 4 includes a cover layer 14 that is spaced apart from the heating element 12. A shield or support structure 40 may be provided on a back side of the heating element or layer 12. An open space 16 between the cover 14 and the heating element 12 may include a layer 20 that may include a detector 30. The detector 30 may be one or more sensors configured to detect contact between the object or target 26 and the cover 14 and/or a proximity of the object or target 26 relative to the cover 14.

For example, if the object or target 26 makes contact with the cover layer 14 for an extended and/or predetermined period of time or is in close proximity to the cover 14 for an extended and/or predetermined period of time, the heat H generated by the heating element 12 may eventually increase or raise the temperature at the interface between the cover 14 and the object or target 26 to a possibly unsafe level and may result in damage and/or burning of the object or target 26. Accordingly, after the detector 30 recognizes the object or target 26 has been in contact with the cover 14 for an extended predetermined period of time or has been in close proximity to the cover 14 for an extended predetermined period of time, the detector 30 may be configured to reduce or power down the heat generated by the heating element 12 to reduce the temperature at the surface of the cover 14.

The detector 30 may include one or more capacitive touch sensors, force sensitive touch sensors, resistive touch sensors, acoustic or optical methods, or a combination thereof. The detector 30 may also be operably coupled with the heating element 12 to detect a change in operating conditions of the detector 30 and/or heating element 12 that are indicative of the presence or close proximity of an object or target 26. For example, either one of the detector 30 and or heating element 12 may be used as a ground in an electrical circuit that senses a change in capacitance due to the presence or close proximity of an object or target 26 to the detector 30 or heating element 12.

The detector 30 may comprise a material that has a low thermal effusivity in the ranges discussed above when describing the cover 14 and/or the layers 20. For example, the thermal effusivity of the detector may be in a range of about 20-300 Ws^{(1/2)}/m²K. Reasons for the material of the detector 30 may be the same as the reasons for the cover 14 having the low thermal effusivity.

The detector 30 may be provided anywhere on or in the heater 10 (i.e., in, on, and/or between any of the layers) but is preferably disposed somewhere between the cover 14 and the heating element 12. One or more additional layers may be provided between the heating element 12 and the detector 30 and/or between the detector 30 and the cover layer 14, as long as the detector 30 is preferably sandwiched or located somewhere between the cover 14 and the heating element 12.

With continued reference to FIG. 4, the heater 10 includes an insulation or spacer layer 32. The insulation or spacer layer 32 may be located adjacent to or in contact with a back side of the heating element 12. The insulation of spacer layer 32 may be sandwiched or located between the back side of the heating element 12 and a support structure 112 or frame of the vehicle 100 (See support structure 112 at FIG. 1 and vehicle 100 at FIG. 3) or a component of the vehicle 100 like a seat frame, roof of the vehicle, dash board frame, etc. As was discussed above with reference to FIG. 1, the thermal resistance between the heating element 12 and/or heater 10 and support structure 112 of the vehicle 100 may be preferably higher than the thermal resistance between the heating element 12 and/or heater 10 and the cover 14 and the detector 30 to help ensure that the generated heat H is transferred from the heating element 12 in a direction to the cover 14 and towards the occupant or target 26, as opposed to the generated heat H transferring to or in a direction of the support structure 112.

The insulation or spacer layer 32 may be or may include a large pore structure, such as, for example, a 3MESH® spacer fabric from Muller Textiles. The pores may be on the order or about 5 mm or less, 4 mm or less, 3 mm or less, 2 mm or less, 1 mm or less. The insulation of spacer layer 32 may be porous to provide or allow for air to circulate at a back side of the heating element 12 to accelerate a cool down after the heater 10 is turned OFF or provided with reduced power after the detector 30 identifies that an object or target 26 has been in contact with the cover 14 for an extended predetermined period of time or has been in close proximity to the cover 14 for an extended predetermined period of time. A thickness of the insulation or spacer layer 32 may be on the order of about 20 mm or less, 15 mm or less, 10 mm orless, 5 mm or less, 2 mm or less.

FIG. 5 is a schematic of another heater 10. Like numerals represent similar features; thus, their structure and function will not be repeated. The open space 16 defined between the beating element 12 and the cover 14 is occupied by one or more layers 20, which may include the detector 30; an insulation or spacer layer 34; a guard or dielectric 36; and insulation or spacer layer 38. The detector 30 is layered or sandwiched between the heating element 12 and the cover 14.

The insulation or spacer layer 34, the guard or dielectric 36, and the insulation or spacer layer 38 may be layers sandwiched, bonded, or otherwise stacked on top of one another. The layers 34, 36, 38 may also be formed or arranged by applying an adhesive to the heating element 12 and then applying flocking of a short fiber material. Flocking may advantageously accommodate differential thermal expansion from heating hot spots that may undesirably cause readthrough issues.

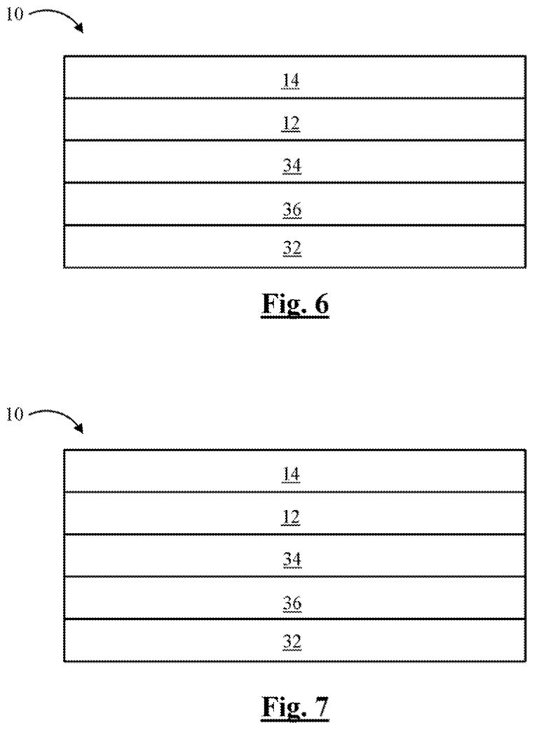

FIGS. 6 and 7 show additional schematics of heaters 10. Like numerals represent similar features; thus, their structure and function will not be repeated. In FIG. 6, the heater 10 includes a cover layer 14, a heating element 12, an insulation or spacer layer 34, a guard or dielectric 36, and an insulation or spacer 32. The insulation layer 34 may have a thickness that is less than a thickness of the insulation layer 32, or vice versa. For example, insulation layer 34 may have suitable thickness such as about 3 mm or more, and the insulation layer 32 may have a suitable thickness of about 10 mm or more. For example, the guard or dielectric 36 in FIG. 6 may be high density.

In FIG. 7, on the back side of the heating element 12 opposite the cover 14, the heater 10 includes an insulation of spacer layer 34, a guard 36, and an additional insulation or spacer 36. These layers 34, 36, 32 and any other layers located on a back side of the heating element 12 in the other figures may assist in reducing the amount of radiative heating that does not get directed towards the cover 14. For example, the guard or dielectric 36 in FIG. 6 may be a low-density structure.

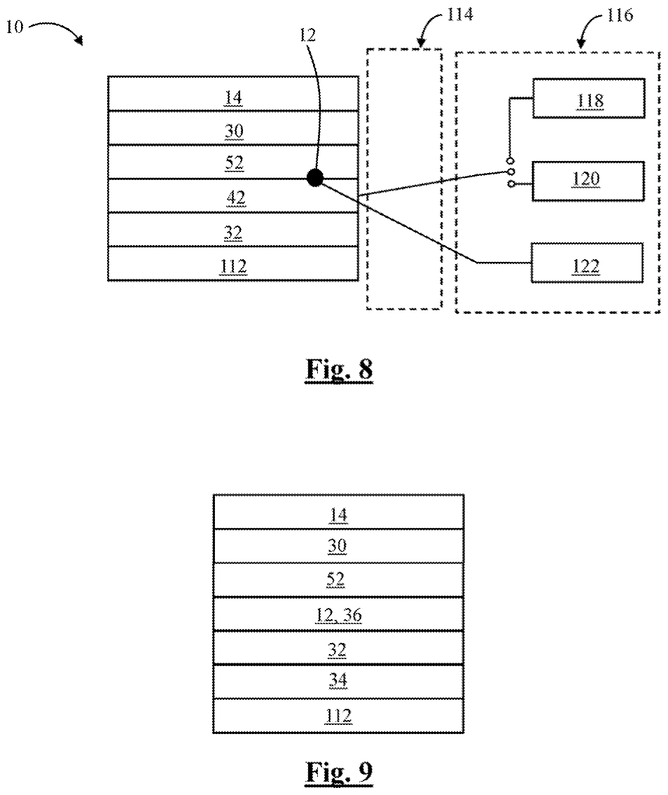

FIG. 8 illustrates a heater 10. The heater 10 includes a trim or cover layer 10, a detector 30, a separation layer or film 52 that includes a heater or heating layer 12, a guard or heater 42, an insulator layer 32 and a support structure or layer 112. The insulator layer 32 may have a suitable thickness, for example on the order of about 8 mm, but any thickness received herein may be used.

The heater 10 is electrically connected to a harness 114 and a controller 116. However, it is understood that the harness and controller may be a single device. The harness 114 electrically connects the controller 116 to the heater 10. The controller 116 may be located inside of a vehicle and includes a detector 118, a power source 120 or connection to a power source, and a temperature sensor 122. The detector 118 may be a person or object sensor, to detect presence and/or proximity of an object or person. The temperature sensor 122 is configured to measure a temperature of the heating layer 12, the heater 10, and/or an area surrounding or adjacent to the heater 10. The controller 116 may include a switch between the power source 120 and the detector 118, which can be enabled to supply or cut supply of power to the heating layer or element depending on presence or absence of a person or object.

FIG. 9 illustrates a heater 10. Any description relating to the heater, the one or more layers or components of the heater, and/or the structure and orientation of the heater and/or one or more layers of the heater in FIG. 9 may apply to any and all examples disclosed herein.

The heater 10 comprises a trim cover layer 14, a detector 30, a separation layer or film 52, a guard or heater layer 12, 36, an insulation layer 32, another insulation layer 34, and a support structure 112. The separation layer or film 52 may be an insulator material or layer disclosed herein. The separation layer or film 52 may comprise a film or layer of Polyimide (PI) and/or Thermoplastic Polyurethane (TPU). The insulation layer 32 may have a thickness that is smaller than insulation layer 34, or vice versa. For example, insulation layer 32 may have a thickness of about 3 mm and the insulation layer may be a foam having a thickness of about 8 mm.

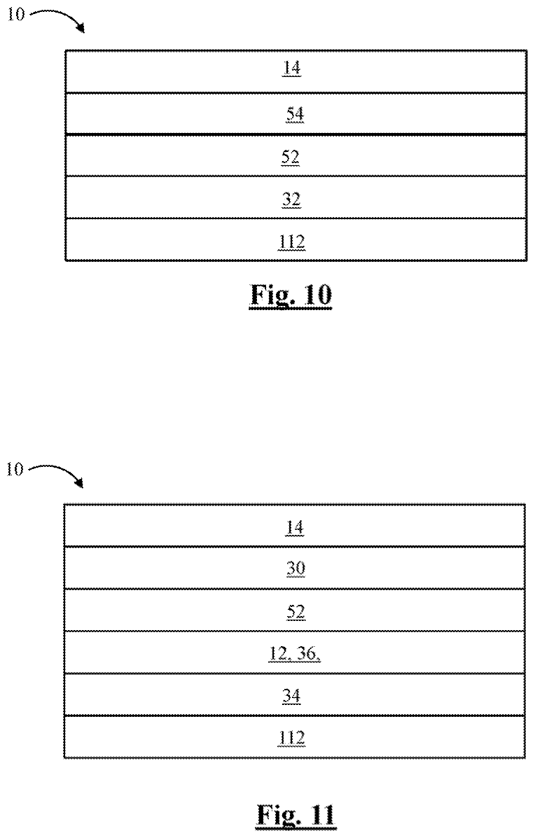

FIG. 10 illustrates a heater 10. The heater 10 includes a trim or cover layer 14, a sensor layer 54 that may include an aluminum (AL) or copper (CU) or copper cladded aluminum (CCA) film. The sensor layer 54 may include 1 or more lines, 2 or more lines, 3 or more lines, or 1-3 lines that may be generally parallel. These lines may be conduits for heater and sensor/shield functions. The heater 10 may include an electrical insulation layer or film 52, a thermal insulation layer 32, and a support structure 112.

FIG. 11 illustrates a heater 10. The heater 10 of FIG. 11 includes a trim or cover layer 14, a sensor layer 30, an electrical insulation layer or film 52, a heater 12 and guard 36, a thermal insulator 34, and a support structure 112. The heater 12 and/or guard 36 may include a resistive wire or conductive film that may be a PL+CCA conductive film or a conductive film, fabric, mesh, and/or nonwoven.

The heater 10 disclosed herein is constructed from lightweight and flexible materials that are configured to conform to various styling contours and surfaces in a vehicle 100. Accordingly, the heater 10 may be provided in areas that traditionally did not include heaters 10, or the heaters 10 may be hidden behind the A-surface of various features of the vehicle 100, thus improving interior aesthetics of the vehicle 100. Moreover, the heater 10 supports various vehicle interior impact regulations that require energy absorbing methods for crash conditions to be free of sharp, rigid, corner construction, which may be typical of traditional encases radiative heaters.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of “a” or “one” to describe an element or step is not intended to foreclose additional elements or steps.

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The disclosures of all articles and references, including patent applications and publications, are incorporated by reference for all purposes. Other combinations are also possible as will be gleaned from the following claims, which are also hereby incorporated by reference into this written description.

1) A heater comprising:
a cover layer; and
a heating layer configured to generate heat that is transferred through the cover layer via radiative heating and/or conductive heating;
wherein the cover layer comprises a thermal effusivity in a range of about 20-300 Ws^{(1/2)}/m²K.

2) The heater according to claim 1, wherein the hearer comprises one or more layers between the cover layer and the heating layer, and the thermal effusivity of both of the cover layer and the heating layer is in the range of about 20-300 Ws^{(1/2)}/m²K.

3) The heater according to claim 1, comprising at least one configuration selected from a group consisting of:
) wherein the radiative heating is in a range between about 42° C. and 120° C.;
ii) wherein the radiative heating has a heat flux of between about 500-5000 W/m²;
iii) wherein the heat flux of the radiative heating is greater than a heat flux of the conductive heating.

4) The heater according to claim 3, wherein the heater comprises an adhesive provided on the heating layer and the cover layer comprises flocking.

5) The heater according to claim 4, wherein the heater comprises a support structure provided on a back side of the heating layer and a thermal resistance between the heating layer and the support structure is higher than a thermal resistance between the heating layer and the cover layer.

6) The heater according to claim 1, wherein the cover laver comprises a thermal emissivity having a range between about 0.8 and 0.95.

7) The heater according to claim 1, wherein the heater comprises a spacer layer disposed between the heating layer and the cover layer.

8) The heater according to claim 7, wherein the spacer layer comprises a thermal effusivity in a range of about 20-300 Ws^{(1/2)}/m²K.

9) The heater according to claim 8, wherein the heater comprises a detector that is configured to detect contact of the cover with an object or a proximity of the object relative to the cover layer.

10) The heater according to claim 9, wherein a thermal effusivity of the detector is in a range of about 20-300 Ws^{(1/2)}/m²K.

11) The heater according to claim 1, wherein the heater comprises an open space or layer defined between the heating layer and the cover layer.

12) (canceled)

13) The heater according to claim 5, comprising an insulation layer between the back side of the heating element and the support structure.

14) The heater according to claim 13, wherein the insulation layer comprises pores that allow air to circulate at the back side of the heating element to accelerate a cool down of the heating layer after the heating layer is turned OFF.

15) The heater according to claim 14, wherein the heating layer comprises a resistive heating wire.

16) The heater according to claim 15, wherein another cover layer is applied over the flocking.

17) The heater according to claim 4, wherein the flocking is configured to move locally with different thermal expansion locations of the heating element.

18) The heater according to claim 1, wherein the cover layer comprises flocking that is adhered directly to the heating element, and the heating element heating element is flexible and configured to conform to a curved surface having at least two degrees of curvature.

19) The heater according to claim 18, wherein the heater comprises a support structure provided on a back side of the heating layer and a thermal resistance between the heating layer and the support structure is higher than a thermal resistance between the heating layer and the cover layer.

20) The heater according to claim 1, wherein the thermal effusivity is expressed as e:=(kpCp)^{1/2}, where k is the thermal conductivity, p is density, and Cp is specific heat capacity.

21) A vehicle class A surface comprising the heater according to claim 18.
